(19) United States
(12) Patent Application Publication
(10) Pub. No.: US 2020/0167788 A1
(43) Pub. Date: May 28, 2020

(54) FRAUDULENT REQUEST IDENTIFICATION FROM BEHAVIORAL DATA

(71) Applicants: Kevin Bell, San Francisco, CA (US); Kerry Boesel, San Francisco, CA (US); Tyua Larsen Fraser, Livermore, CA (US); Patricia Hinrichs, San Francisco, CA (US); Ami Warren Lyman, Matthews, NC (US); Christina Ann Parks, Shoreview, MN (US); Michael Rosenthal, San Francisco, CA (US); Angela Sicord, San Francisco, CA (US); Keith Meade Sykes, Charlotte, NC (US); Steve Watts, San Francisco, CA (US)

(72) Inventors: Kevin Bell, San Francisco, CA (US); Kerry Boesel, San Francisco, CA (US); Tyua Larsen Fraser, Livermore, CA (US); Patricia Hinrichs, San Francisco, CA (US); Ami Warren Lyman, Matthews, NC (US); Christina Ann Parks, Shoreview, MN (US); Michael Rosenthal, San Francisco, CA (US); Angela Sicord, San Francisco, CA (US); Keith Meade Sykes, Charlotte, NC (US); Steve Watts, San Francisco, CA (US)

(21) Appl. No.: 16/201,152

(22) Filed: Nov. 27, 2018

(51) Int. Cl. G06Q 20/40; G06Q 20/16; G10L 25/51; G10L 17/06; G06K 9/00

(52) U.S. Cl. CPC G06Q 20/4016; G06Q 20/40145; G06K 9/00483; G10L 25/51; G10L 17/06; G06Q 20/16

(57) ABSTRACT

Various examples described herein are directed to systems, methods, and computer-readable medium for routing distribution requests. A request for distribution of funds is received. The funds are in an account of a user. An activity window is determined. Data from within the activity window is collected. A risk score is calculated based on the data. The request is routed to a further verification queue based on the risk score. Additional information needed to verify the request is determined. The additional information is requested and received. The additional information is verified. Approval of the request is determined based on the verification of the additional information.

### BACKGROUND

Financial institutions routinely encounter fraudulent requests for monetary distributions. These fraudulent requests may be done with intricate knowledge of the internal processes of the financial institution. Accordingly, the requests may be multifaceted in an attempt to fraudulently request distribution of moneys. For example, a fraudster may call of a customer service representative for help regarding an account to gain additional information or to change some data associated with the account. This information and changed data may then be exploited at a later time to request a fraudulent money distribution. As these requests are fraudulent, identifying and preventing such distributions is beneficial to the financial instruction that receives a fraudulent request.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a block diagram showing a system for routing a distribution request according to some embodiments.

FIG. 2 is a flow diagram showing a distribution request routing process according to some embodiments.

FIG. 3 is a block diagram showing one example of a software architecture for a computing device.

FIG. 4 is a block diagram illustrating a computing device hardware architecture, within which a set or sequence of instructions can be executed to cause the hardware to perform examples of any one of the methodologies discussed herein.

### DETAILED DESCRIPTION

The growth of communication systems now allows users to remotely request distribution of money from their accounts. These distributions can include large amounts of money for users. For example, distribution of retirement savings can be requested without needing to be physically present at any location. Such transactions may be very convenient for customers but may also allow fraudulent transfers to be requested. Identifying and routing potentially fraudulent requests for additional screening and additional verification helps eliminate fraudulent requests. Identifying potentially fraudulent requests allows the vast majority of requests, which are not fraudulent, to be handled quickly and efficiently. Without being able to identify potentially fraudulent requests, all requests may be subjected to additional screenings, which could increase processing time for all distribution request. Using various described embodiments, processing time for valid requests may be reduced, while potentially fraudulent requests are identified and subjected to additional verification.

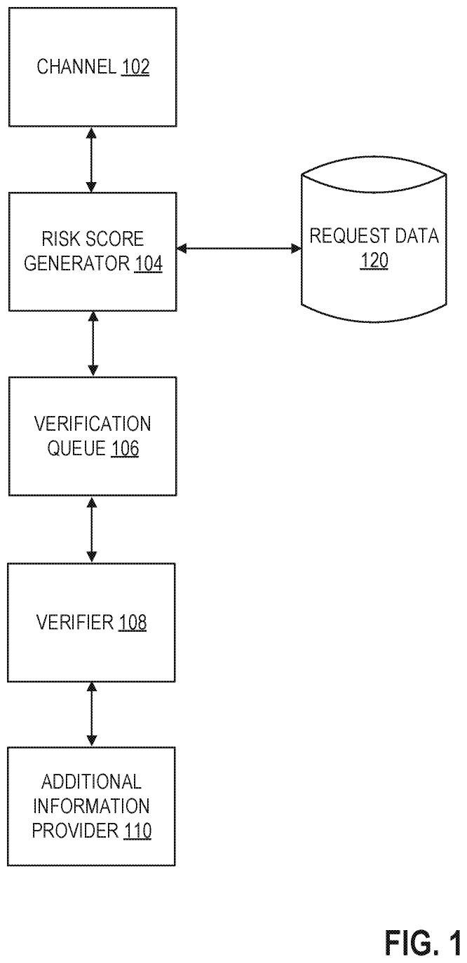

FIG. 1 is a block diagram showing a system 100 for routing a distribution request according to some embodiments. Information regarding an account may be received from a channel 102. The channel 102 is any means by which information may be obtained, such as via a website, a phone call, an internal interface, etc. The channel 102 where information is received may impact the quality and trustworthiness of the information. For example, information input via an internal interface that was received during an in-person visit at a branch may be deemed more reliable than data received via a website.

In an example, a request to distribute funds from an account may be received from the channel 102. For example, a phone call may be received and the caller may request that funds be transferred from a source account to a destination account. Call tracking software may be used to help manage the request as well as provide information about the source account, the destination account, the owner of the accounts, and past requests and communications with the owner.

In an example, a risk score, calculated by a risk score generator 104, associated with the call, the service account, the destination account, or the caller may be calculated and provided to an operator handling the call via the call tracking software. The risk score generator 104 may use previous request data 120 to calculate the risk score. The request data 120 may include transaction data across multiple channels that provides patterns of behavior for account accesses. For example, the request data 120 may include changes made to the source account and the destination account. These changes may include changes to a phone number, address, personal identification number, etc. In addition, the request data 120 may indicate when the changes were made and the channel used to make the change.

The risk score generator 104 may use this data to calculate the risk score. In an example, only data within a recent window, such as 10, 30, 60, 90 days, is used. The risk score generator 104 may take into account the type of change the channel used to make the change in calculating the risk score. For example, recent changes made to an account via an online channel may increase the risk score. The increased risk score may indicate that the changes have not yet been independently verified. In addition, the risk score generator 104 may take into account the amount of the distribution request, the age of the destination account, the company associated with the source account, an owner's job title, a request for expedited handling, etc. For example, a company may have multiple retirement accounts with a financial institution. That company may have recently been a victim of a cybersecurity attack. Based on this, requests to transfer money out of a retirement account associated with the company may have an increased risk score.

As another example, multiple accounts may belong to a common plan. Multiple fraudulent requests may be identified regarding accounts that belong to the common plan. Based on this identification, additional requests associated with an account belonging to the plan may have an increased risk score. Accordingly, the requests data 120 itself may be used to identify trends that indicate a higher risk score and, therefore, additional verification or processing may be warranted.

Based on the risk score, the request may be routed to a verification queue 106. The verification queue 106 may determine a verifier 108 to verify the request. For example, the verifier 108 may request a user to provide additional assurances such as responding to an email or text message sent to an address or phone number associated with the source account. Other examples of additional information may include a voiceprint, a thumbprint, signature, etc. An additional information provider 110 provides the requested information to the verifier 108. The verifier 108 may then verify the transaction based on the additional information. The verification queue 106 may receive the approval from the verifier 108. The verification queue 106 may provide the approval to the risk score generator 104 or the channel 102. In some examples, the additional verification is completed after the initial distribution request. For example, a user may call in to request a distribution. Following the completion of the request call, the additional verification may be completed. In this example, an indication of the verification may be provided to the user via contact information associated with the user's account. If a request is not verified, an indication regarding the failed verification may be logged in the request data 120. The data associated with the failed request may be used with future requests to further identify fraudulent requests. For example, a recording of any calls associated with the failed request may be stored. In addition, a voice print of the caller may be extracted from the recordings and used as a voice print to identify the same caller for future distribution requests.

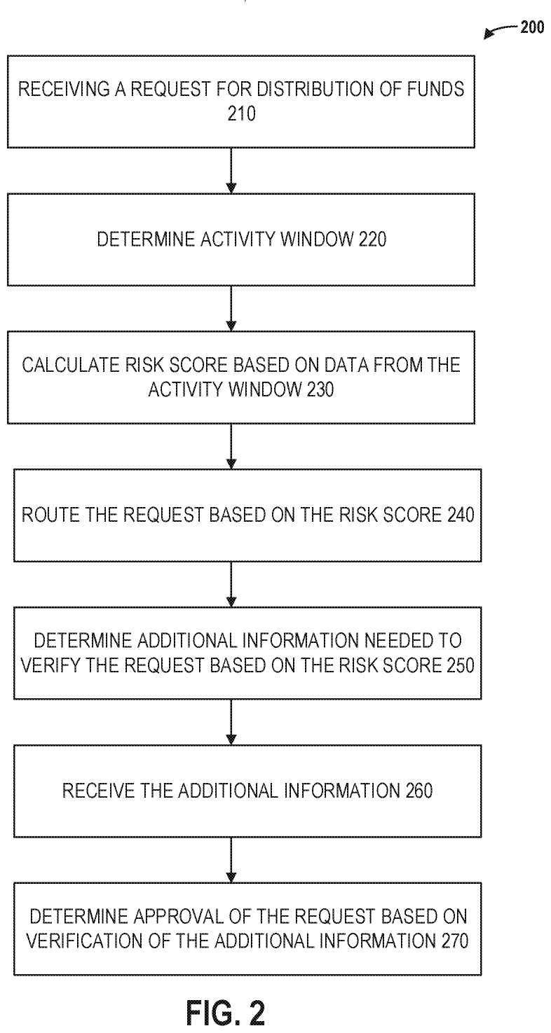

FIG. 2 is a flow diagram showing a distribution request routing process 200 according to some embodiments. At 210, a request for distribution of funds from an account of a user is received. The request may be received over a channel, such as the channel 102. For example, the request may be received via a website, a phone call, or via an in-branch request. At 220, an activity window is determined. The activity window determines a limit to the data that is used to calculate the risk score. For example, the activity window may be used to limit the data retrieved that is used to calculate the risk score. In an example, the activity window may be 30, 60, or 90 days. In these examples, only data within the last 30, 60, or 90 days is used to calculate the risk score. As another example, the activity window is determined based on data, such as the request data. For example, a source company associated with the account is determined. The company may be the current or past employer of the user. A high-alert list, which may be stored in the request data, may be searched. The high-alert list may be a list of companies that have had cyber security attacks within the last six months, year, etc. The high-alert list may also include companies that are associated with accounts that have had recent fraudulent requests. The company being on the high-alert list may be used to determine the activity window. For example, the activity window may be 30 days if the company is not on the list but 60 days if the company is found on the list.

Data associated with the request is retrieved using the activity window. For example, only data within the activity window is retrieved. The data may include a number of times certain data changed within the activity window. For example, the number of times a phone number or mailing address associated with the account were changed may be included in the data. One way a fraudulent request may be tried is to change a mailing address or phone number and then request a distribution. The data may also include an age of the destination account. For example, the opening date may be used to determine the destination account was opened within the activity window. Data may also include a location from which the customer is calling or an address or location associated with an internet protocol (IP) address of a request.

At 230, a risk score is calculated based on the data from the activity window. The risk score may take into account the request data that is within the activity window as well as data associated with the current request. For example, the current request may be initiated with a phone call. Voice data of the call may be compared to voice data from previously identified fraudulent requests. If there is a match, the risk score may be adjusted to indicate the current request is a fraudulent request. This example requires voice data of known fraudulent requests. In an example, to determine fraudulent requests without requiring voice data from fraudulent requests, the voice data of the current request may be compared to voices from other calls that request a distribution from a different account. In an example, the calls requesting distribution from accounts not associated with the current user are used. These voices from these calls should not match the current caller, since the calls are requesting distribution from accounts not associated with the current caller. If a match is found, meaning the same person is requesting a distribution from two different accounts not jointly owned, the risk score may be adjusted to indicate a higher likelihood of fraud.

The risk score may also be adjusted based on the plan of the account. For example, the account may one account in an employer's retirement plan. Fraud activity associated with other accounts within the plan may be searched for and retrieved. Known fraudulent requests from other plan accounts may be used to adjust the risk score to indicate a higher likelihood that the current request is fraudulent.

The risk score may also be based on if the mailing address, phone number, email, other contact information associated with the account has changed within the activity period. Changes within the activity period may indicate possible fraud. In addition, the channel used to make the changes may be used to calculate the risk score. Channels were the data may not be independently verified may have a higher risk score than other channels. For example, changes made over the phone may have a higher risk score than those made at a branch location. The risk score may also be based on the distribution amount of the request. In addition, if the user is identified as an executive or whose accounts have a value above a threshold may have an increased risk score.

The risk score may indicate a greater risk for requests that originate from locations that are areas known from previous fraud requests or are a long distance from any address associated with the account. For example, a request originating in a country outside of the residence country of the account may have the risk score increased. In addition, out of state origination or mileage from the user's address may be used in calculating the risk score.

At 240, the request is routed based on the risk score. If the risk score is low, the request may be routed for automatic processing without further input. If the risk score is above a threshold, however, the request is routed for additional processing. For example, the request may be routed to a verification queue based on the risk score. The verification queue is a queue that holds requests that requires some additional verification before the request is processed.

At 250, additional information that is needed to verify the request is determined. The additional information may be based on the risk score. For example, the risk score may require that that the additional information is for the user to physically come into a branch office, sign a corresponding authorization for the request, and provide identification. The additional information may then be requested from the user. At 260, the additional information is received. The additional information may then be verified. At 270, the request may be approved based on the verification of the additional information.

In an example, the additional information includes bioinformatic data. For example, the additional information may be for voice print data. A message to the user may be created that provides instructions to call a phone number. When the user calls the phone number, a recording of the user may be done. As another example, a call may be automatically placed to a phone number associated with the account and the voice recording may be done as part of the automatically placed call. In some examples, the automatic call is placed only if the phone number associated with an account has not changed within the activity window. The voice recording may represent the additional information. The recording may be compared to the voice that requested the original distribution. Upon a match, the request for distribution may be approved.

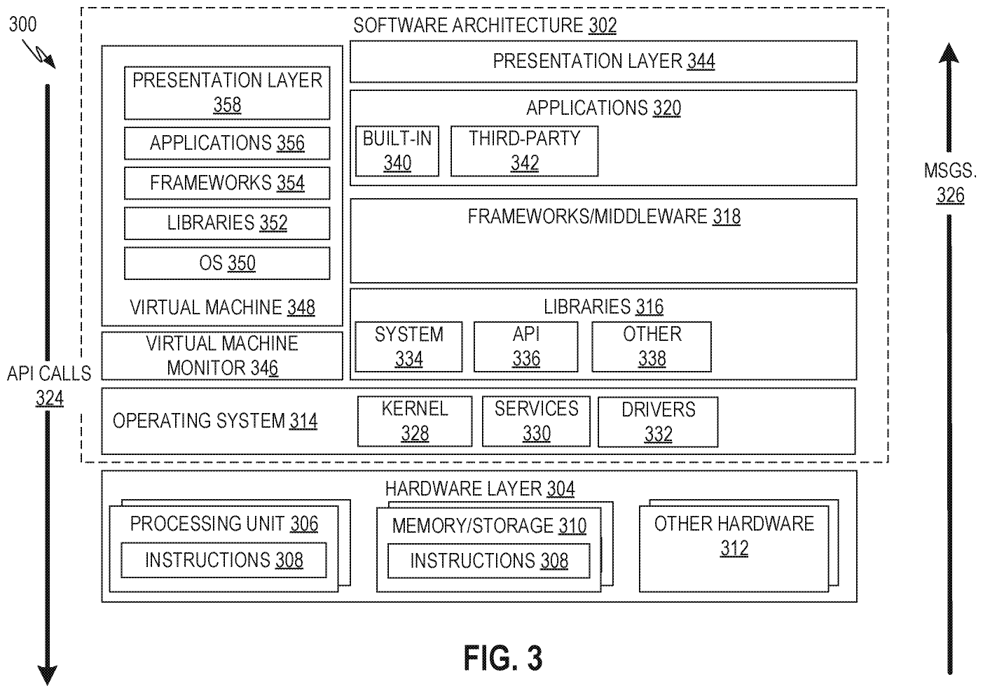

FIG. 3 is a block diagram 300 showing one example of a software architecture 302 for a computing device. The architecture 302 may be used in conjunction with various hardware architectures, for example, as described herein. The software architecture 302 may be used to implement the risk score generator 104, the verification queue 106, the verifier 108, and the process 200. FIG. 3 is merely a non-limiting example of a software architecture 302 and many other architectures may be implemented to facilitate the functionality described herein. A representative hardware layer 304 is illustrated and can represent, for example, any of the above referenced computing devices. In some examples, the hardware layer 304 may be implemented according to the architecture 302 of FIG. 3.

The representative hardware layer 304 comprises one or more processing units 306 having associated executable instructions 308. Executable instructions 308 represent the executable instructions of the software architecture 302, including implementation of the methods, modules, components, and so forth of FIGS. 1-2. Hardware layer 304 also includes memory and/or storage modules 310, which also have executable instructions 308. Hardware layer 304 may also comprise other hardware as indicated by other hardware 312 which represents any other hardware of the hardware layer 303, such as the other hardware illustrated as part of hardware architecture 400.

In the example architecture of FIG. 3, the software architecture 302 may be conceptualized as a stack of layers where each layer provides particular functionality. For example, the software architecture 302 may include layers such as an operating system 314, libraries 316, frameworks/middleware 318, applications 320 and presentation layer 344. Operationally, the applications 320 and/or other components within the layers may invoke application programming interface (API) calls 324 through the software stack and receive a response, returned values, and so forth illustrated as messages 326 in response to the API calls 324. The layers illustrated are representative in nature and not all software architectures have all layers. For example, some mobile or special purpose operating systems may not provide a frameworks/middleware layer 318, while others may provide such a layer. Other software architectures may include additional or different layers.

The operating system 314 may manage hardware resources and provide common services. The operating system 314 may include, for example, a kernel 328, services 330, and drivers 332. The kernel 328 may act as an abstraction layer between the hardware and the other software layers. For example, the kernel 328 may be responsible for memory management, processor management (e.g., scheduling), component management, networking, security settings, and so on. The services 330 may provide other common services for the other software layers. In some examples, the services 330 include an interrupt service. The interrupt service may detect the receipt of a hardware or software interrupt and, in response, cause the software architecture 302 to pause its current processing and execute an interrupt service routine (ISR) when an interrupt is received. The ISR may generate the alert, for example, as described herein.

The drivers 332 may be responsible for controlling or interfacing with the underlying hardware. For instance, the drivers 332 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 316 may provide a common infrastructure that may be utilized by the applications 320 and/or other components and/or layers. The libraries 316 typically provide functionality that allows other software modules to perform tasks in an easier fashion than to interface directly with the underlying operating system 314 functionality (e.g., kernel 328, services 330 and/or drivers 332). The libraries 316 may include system 334 libraries (e.g., C standard library) that may provide functions such as memory allocation functions, string manipulation functions, mathematic functions, and the like. In addition, the libraries 316 may include API libraries 336 such as media libraries (e.g., libraries to support presentation and manipulation of various media format such as MPEG3, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like. The libraries 316 may also include a wide variety of other libraries 338 to provide many other APIs to the applications 320 and other software components/modules.

The frameworks 318 (also sometimes referred to as middleware) may provide a higher-level common infrastructure that may be utilized by the applications 320 and/or other software components/modules. For example, the frameworks 318 may provide various graphic user interface (GUI) functions, high-level resource management, high-level location services, and so forth. The frameworks 318 may provide a broad spectrum of other APIs that may be utilized by the applications 320 and/or other software components/modules, some of which may be specific to a particular operating system or platform.

The applications 320 includes built-in applications 340 and/or third party applications 342. Examples of representative built-in applications 340 may include, but are not limited to, a contacts application, a browser application, a book reader application, a location application, a media application, a messaging application, and/or a game application. Third party applications 342 may include any of the built in applications as well as a broad assortment of other applications. In a specific example, the third party application 342 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third party application 342 may invoke the API calls 324 provided by the mobile operating system such as operating system 314 to facilitate functionality described herein.

The applications 320 may utilize built in operating system functions (e.g., kernel 328, services 330 and/or drivers 332), libraries (e.g., system 334, APIs 336, and other libraries 338), frameworks/middleware 318 to create user interfaces to interact with users of the system. Alternatively, or additionally, in some systems interactions with a user may occur through a presentation layer, such as presentation layer 344. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 3, this is illustrated by virtual machine 348. A virtual machine creates a software environment where applications/modules can execute as if they were executing on a hardware computing device. A virtual machine is hosted by a host operating system (operating system 314) and typically, although not always, has a virtual machine monitor 346, which manages the operation of the virtual machine as well as the interface with the host operating system (i.e., operating system 314). A software architecture executes within the virtual machine such as an operating system 350, libraries 352, frameworks/middleware 354, applications 356 and/or presentation layer 358. These layers of software architecture executing within the virtual machine 348 can be the same as corresponding layers previously described or may be different.

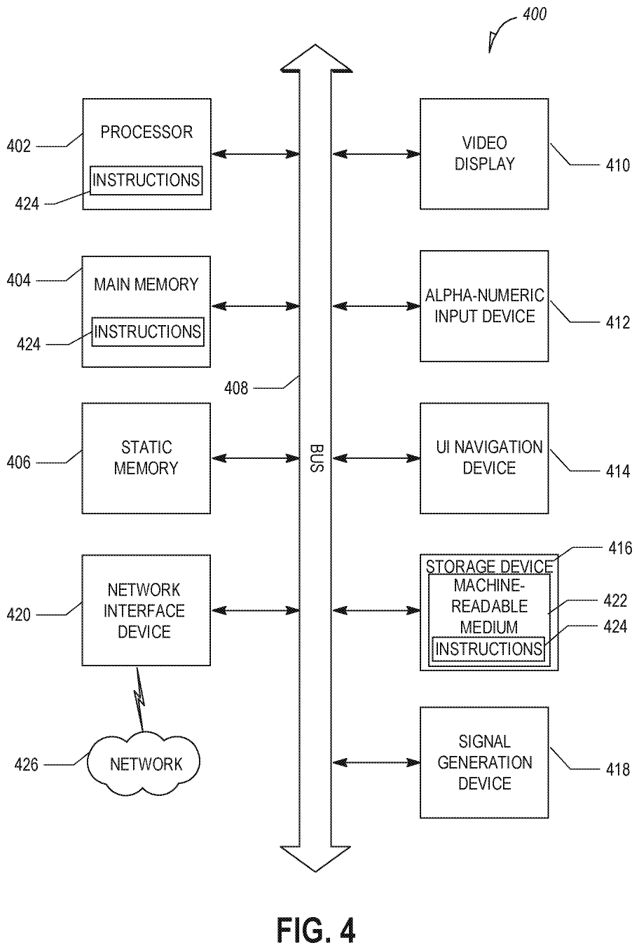

FIG. 4 is a block diagram illustrating a computing device hardware architecture 400, within which a set or sequence of instructions can be executed to cause the machine to perform examples of any one of the methodologies discussed herein. For example, the architecture 400 may execute the software architecture 302 described with respect to FIG. 3. The tactile response determiner 108 and the process 300 may also be executed on the architecture 400. The architecture 400 may operate as a standalone device or may be connected (e.g., networked) to other machines. In a networked deployment, the architecture 400 may operate in the capacity of either a server or a client machine in server-client network environments, or it may act as a peer machine in peer-to-peer (or distributed) network environments. The architecture 400 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 400 includes a processor unit 402 comprising at least one processor (e.g., a central processing unit (CPU), a graphics processing unit (GPU) or both, processor cores, compute nodes, etc.). The architecture 400 may further comprise a main memory 404 and a static memory 406, which communicate with each other via a link 408 (e.g., bus). The architecture 400 can further include a video display unit 410, an alphanumeric input device 412 (e.g., a keyboard), and a user interface (UI) navigation device 414 (e.g., a mouse). In some examples, the video display unit 410, input device 412 and UI navigation device 414 are incorporated into a touch screen display. The architecture 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

In some examples, the processor unit 402 or other suitable hardware component may support a hardware interrupt. In response to a hardware interrupt, the processor unit 402 may pause its processing and execute an interrupt service routine (ISR), for example, as described herein.

The storage device 416 includes a machine-readable medium 422 on which is stored one or more sets of data structures and instructions 424 (e.g., software) embodying or utilized by any one or more of the methodologies or functions described herein. The instructions 424 can also reside, completely or at least partially, within the main memory 404, static memory 406, and/or within the processor 402 during execution thereof by the architecture 400, with the main memory 404, static memory 406, and the processor 402 also constituting machine-readable media. Instructions stored at the machine-readable medium 422 may include, for example, instructions for implementing the software architecture 402, instructions for executing any of the features described herein, etc.

While the machine-readable medium 422 is illustrated in an example to be a single medium, the term “machine-readable medium” can include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 can further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

### ADDITIONAL NOTES & EXAMPLES

Example 1 is an apparatus for routing requests, the apparatus comprising: an electronic processor configured to: receive a request for distribution of funds, wherein the funds are in an account of a user; determine an activity window; collect data from within the activity window associated with the account and the user; calculate a risk score based on the data; route, to a further verification queue, the request based on the risk score; determine additional information needed to verify the request based on the risk score; request the additional information; receive the additional information; verify the additional information; and determine approval of the request based on the verification of the additional information.

In Example 2, the subject matter of Example 1 includes, wherein to determine the activity window the electronic processor is further configured to: determine a source company associated with the account of the user; determine the company is listed on a high-alert list; and determine the activity window based on the company being on the high-alert list.

In Example 3, the subject matter of Example 2 includes, wherein the activity window is between 30 and 90 days inclusive.

In Example 4, the subject matter of Examples 1-3 includes, wherein the data comprises a number of times a mailing address associated with the account has changed within the activity window.

In Example 5, the subject matter of Examples 1-4 includes, wherein the data comprises a number of times a phone number associated with the account has changed within the activity window.

In Example 6, the subject matter of Examples 1-5 includes, wherein the data comprises an opening date of a destination account where funds will be transferred.

In Example 7, the subject matter of Examples 1-6 includes, wherein to calculate a risk score the electronic processor is further configured to: receive voice data of a call that generated the request; compare the voice data to voice data from previous fraud requests; determine a match between the voice data and the voice data from previous fraud requests; and adjust the risk score to indicate a fraudulent request based on the match.

In Example 8, the subject matter of Examples 1-7 includes, wherein to calculate a risk score the electronic processor is further configured to: receive voice data of a call that generated the request; receive voice data from other calls that requested a distribution from accounts other than the then account of the user; compare the voice data to the voice data from other calls; determine a match between the voice data and the voice data from other calls; and adjust the risk score to indicate a fraudulent request based on the match.

In Example 9, the subject matter of Examples 1-8 includes, wherein to calculate a risk score the electronic processor is further configured to: determine a plan of the account; search for fraud activity of other accounts within the plan; and adjust the risk score to indicate a fraudulent request based on found fraud activity of other accounts within the plan.

In Example 10, the subject matter of Examples 1-9 includes, wherein the risk score is based on distribution amount of the request.

In Example 11, the subject matter of Examples 1-10 includes, wherein the additional information comprises bioinformatic data.

In Example 12, the subject matter of Example 11 includes, wherein the bioinformatic data comprises voice print data.

Example 13 is a method for providing tactile response, the method comprising operations performed using an electronic processor, the operations comprising: receiving a document comprising visual data to be displayed; receiving change data for the visual data that indicates a change in a data value from a previous time; rendering the visual data; receiving an indication that a section of the document is selected, wherein the section contains a first visual data; determining, from the change data, a change of the first visual data; and controlling a tactile response unit to provide a tactile response based on the change of the first visual data.

In Example 14, the subject matter of Example 13 includes, wherein determining the activity window comprises: determining a source company associated with the account of the user; determining the company is listed on a high-alert list; and determining the activity window based on the company being on the high-alert list.

In Example 15, the subject matter of Example 14 includes, wherein the activity window is between 30 and 90 days inclusive.

In Example 16, the subject matter of Examples 13-15 includes, wherein the data comprises a number of times a mailing address associated with the account has changed within the activity window.

In Example 17, the subject matter of Examples 13-16 includes, wherein the data comprises a number of times a phone number associated with the account has changed within the activity window.

In Example 18, the subject matter of Examples 13-17 includes; wherein the data comprises an opening date of a destination account where funds will be transferred.

In Example 19, the subject matter of Examples 13-18 includes, wherein calculating the risk score comprises: receiving voice data of a call that generated the request; comparing the voice data to voice data from previous fraud requests; determining a match between the voice data and the voice data from previous fraud requests; and adjusting the risk score to indicate a fraudulent request based on the match.

In Example 20, the subject matter of Examples 13-19 includes, wherein calculating the risk score comprises: receiving voice data of a call that generated the request; receiving voice data from other calls that requested a distribution from accounts other than the then account of the user; comparing the voice data to the voice data from other calls; determining a match between the voice data and the voice data from other calls; and adjusting the risk score to indicate a fraudulent request based on the match.

In Example 21, the subject matter of Examples 13-20 includes, wherein calculating the risk score comprises: determining a plan of the account; searching for fraud activity of other accounts within the plan; and adjusting the risk score to indicate a fraudulent request based on found fraud activity of other accounts within the plan.

In Example 22, the subject matter of Examples 13-21 includes, wherein the risk score is based on distribution amount of the request.

In Example 23, the subject matter of Examples 13-22 includes, wherein the additional information comprises bioinformatic data.

In Example 24, the subject matter of Example 23 includes, wherein the bioinformatic data comprises voice print data.

Example 25 is a non-transitory machine-readable medium comprising instructions thereon for providing tactile response that, when executed by a processor unit, causes the processor unit to perform operations comprising: receiving a document comprising visual data to be displayed; receiving change data for the visual data that indicates a change in a data value from a previous time; rendering the visual data; receiving an indication that a section of the document is selected, wherein the section contains a first visual data; determining, from the change data, a change of the first visual data; and controlling a tactile response unit to provide a tactile response based on the change of the first visual data.

In Example 26, the subject matter of Example 25 includes, wherein determining the activity window comprises: determining a source company associated with the account of the user; determining the company is listed on a high-alert list; and determining the activity window based on the company being on the high-alert list.

In Example 27, the subject matter of Example 26 includes, wherein the activity window is between 30 and 90 days inclusive.

In Example 28, the subject matter of Examples 25-27 includes, wherein the data comprises a number of times a mailing address associated with the account has changed within the activity window.

In Example 29, the subject matter of Examples 25-28 includes, wherein the data comprises a number of times a phone number associated with the account has changed within the activity window.

In Example 30, the subject matter of Examples 25-29 includes, wherein the data comprises an opening date of a destination account where funds will be transferred.

In Example 31, the subject matter of Examples 25-30 includes, wherein calculating the risk score comprises: receiving voice data of a call that generated the request; comparing the voice data to voice data from previous fraud requests; determining a match between the voice data and the voice data from previous fraud requests; and adjusting the risk score to indicate a fraudulent request based on the match.

In Example 32, the subject matter of Examples 25-31 includes, wherein calculating the risk score comprises: receiving voice data of a call that generated the request; receiving voice data from other calls that requested a distribution from accounts other than the then account of the user; comparing the voice data to the voice data from other calls; determining a match between the voice data and the voice data from other calls; and adjusting the risk score to indicate a fraudulent request based on the match.

In Example 33, the subject matter of Examples 25-32 includes, wherein calculating the risk score comprises: determining a plan of the account; searching for fraud activity of other accounts within the plan; and adjusting the risk score to indicate a fraudulent request based on found fraud activity of other accounts within the plan.

In Example 34, the subject matter of Examples 25-33 includes, wherein the risk score is based on distribution amount of the request.

In Example 35, the subject matter of Examples 25-34 includes; wherein the additional information comprises bioinformatic data.

In Example 36, the subject matter of Example 35 includes, wherein the bioinformatic data comprises voice print data.

Example 37 is at least one machine-readable medium including instructions that, when executed by processing circuitry, cause the processing circuitry to perform operations to implement of any of Examples 1-36.

Example 38 is an apparatus comprising means to implement of any of Examples 1-36.

Example 39 is a system to implement of any of Examples 1-36.

Example 40 is a method to implement of any of Examples 1-36.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. An apparatus for routing requests, the apparatus comprising:
an electronic processor configured to:
receive a request for distribution of funds, wherein the funds are in an account of a user;
determine an activity window;
collect data from within the activity window associated with the account and the user;
calculate a risk score based on the data;
route, to a further verification queue, the request based on the risk score;
determine additional information needed to verify the request based on the risk score;
request the additional information;
receive the additional information;
verify the additional information; and
determine approval of the request based on the verification of the additional information.

2. The apparatus of claim 1, wherein to determine the activity window the electronic processor is further configured to:
determine a source company associated with the account of the user;
determine the company is listed on a high-alert list; and
determine the activity window based on the company being on the high-alert list.

3. The apparatus of claim 2, wherein the activity window is between 30 and 90 days inclusive.

4. The apparatus of claim 1, wherein the data comprises a number of times a mailing address associated with the account has changed within the activity window.

5. The apparatus of claim 1, wherein the data comprises a number of times a phone number associated with the account has changed within the activity window.

6. The apparatus of claim 1, wherein the data comprises an opening date of a destination account where funds will be transferred.

7. The apparatus of claim 1, wherein to calculate a risk score the electronic processor is further configured to:
receive voice data of a call that generated the request;
compare the voice data to voice data from previous fraud requests;
determine a match between the voice data and the voice data from previous fraud requests; and
adjust the risk score to indicate a fraudulent request based on the match.

8. The apparatus of claim 1, wherein to calculate a risk score the electronic processor is further configured to:
receive voice data of a call that generated the request;
receive voice data from other calls that requested a distribution from accounts other than the then account of the user;
compare the voice data to the voice data from other calls;
determine a match between the voice data and the voice data from other calls; and
adjust the risk score to indicate a fraudulent request based on the match.

9. The apparatus of claim 1, wherein to calculate a risk score the electronic processor is further configured to:
determine a plan of the account;
search for fraud activity of other accounts within the plan; and
adjust the risk score to indicate a fraudulent request based on found fraud activity of other accounts within the plan.

10. The apparatus of claim 1, wherein the risk score is based on distribution amount of the request.

11. The apparatus of claim 1, wherein the additional information comprises bioinformatic data.

12. The apparatus of claim 11, wherein the bioinformatic data comprises voice print data.

13. A method for providing tactile response, the method comprising operations performed using an electronic processor, the operations comprising:
receiving a document comprising visual data to be displayed;
receiving change data for the visual data that indicates a change in a data value from a previous time;
rendering the visual data;
receiving an indication that a section of the document is selected, wherein the section contains a first visual data;
determining, from the change data, a change of the first visual data; and
controlling a tactile response unit to provide a tactile response based on the change of the first visual data.

14. The method of claim 13, wherein determining the activity window comprises:
determining a source company associated with the account of the user;
determining the company is listed on a high-alert list; and
determining the activity window based on the company being on the high-alert list.

15. The method of claim 14, wherein the activity window is between 30 and 90 days inclusive.

16. The method of claim 13, wherein the data comprises a number of times a mailing address associated with the account has changed within the activity window.

17. A non-transitory machine-readable medium comprising instructions thereon for providing tactile response that, when executed by a processor unit, causes the processor unit to perform operations comprising:
receiving a document comprising visual data to be displayed;
receiving change data for the visual data that indicates a change in a data value from a previous time;
rendering the visual data;
receiving an indication that a section of the document is selected, wherein the section contains a first visual data;
determining, from the change data, a change of the first visual data; and
controlling a tactile response unit to provide a tactile response based on the change of the first visual data.

18. The non-transitory machine-readable medium of claim 17, wherein determining the activity window comprises:
determining a source company associated with the account of the user;
determining the company is listed on a high-alert list; and
determining the activity window based on the company being on the high-alert list.

19. The non-transitory machine-readable medium of claim 18, wherein the activity window is between 30 and 90 days inclusive.

20. The non-transitory machine-readable medium of claim 17, wherein the data comprises a number of times a mailing address associated with the account has changed within the activity window.
